(19) United States
(12) Patent Application Publication
(10) Pub. No.: US 2026/0133644 A1
(43) Pub. Date: May 14, 2026

(54) Touchscreen Finger-Worn Stylus Device

(71) Applicant: Jeff Bowsher, Lima, OH (US)

(72) Inventor: Jeff Bowsher, Lima, OH (US)

(21) Appl. No.: 19/362,600

(22) Filed: Oct. 20, 2025

Related U.S. Application Data
(60) Provisional application No. 63/719,414, filed on Nov. 12, 2024.

(51) Int. Cl. G06F 3/0354; G06F 3/01; G06F 3/039

(52) U.S. Cl. CPC G06F 3/03545; G06F 3/014; G06F 3/0393; G06F 2203/0331

(57) ABSTRACT

A touchscreen finger-worn stylus device is provided. The device is designed to enhance the accuracy and usability of touchscreen interactions, particularly in warehouse, retail, and logistics environments. The device comprises a flexible sleeve-like body that fits securely over a user's finger. The device features a stylus tip made from conductive materials to ensure precise capacitive touchscreen input. The stylus tip may be interchangeable, with options such as a precision rubber tip, soft conductive foam tip, or fine-point stylus tip, secured via an attachment mechanism. Some embodiments of the device include a pressure-sensitive layer for variable touch input and a pressure-relief insert to reduce fingertip strain. The device may also incorporate an adjustable securing mechanism, such as a hook-and-loop strap or elastic band, to prevent unintended movement.

### CROSS-REFERENCE TO RELATED APPLICATION

The present application claims priority to, and the benefit of, U.S. Provisional Application No. 63/719,414, which was filed on Nov. 12, 2024, and is incorporated herein by reference in its entirety.

### FIELD OF THE INVENTION

The present invention relates generally to the field of touchscreen stylus devices. More specifically, the present invention relates to a flexible finger-worn sleeve with a conductive stylus tip for precise capacitive input when engaging touchscreens. Accordingly, the present disclosure makes specific reference thereto. Nonetheless, it is to be appreciated that aspects of the present invention are also equally applicable to other like applications, devices, and methods of manufacture.

### BACKGROUND

In environments where scanning guns and other handheld touchscreen devices are used, accurately selecting on-screen buttons can be challenging. The small size of touchscreen interfaces, combined with the necessity for quick and precise inputs, often leads to frequent errors. Users may struggle to operate these devices effectively, particularly in fast-paced retail and inventory management settings where efficiency is critical. Inaccurate touchscreen interactions can result in delays, frustration, and potential financial losses due to inventory mismanagement. Additionally, extended use of these devices can lead to discomfort or strain, particularly when users must repeatedly tap small targets on the screen. The problem is further exacerbated when workers need to operate other equipment simultaneously, making it difficult to use both hands efficiently. Traditional styluses are often impractical for these environments, as they require a dedicated grip and can be easily misplaced.

Therefore, there exists a long-felt need in the art for a touchscreen finger-worn stylus device that allows users to accurately select touchscreen elements on scanning guns and other handheld devices. There also exists a long-felt need in the art for a touchscreen finger-worn stylus device that improves workflow efficiency by enabling users to interact with touchscreens while simultaneously handling inventory or equipment. Moreover, there exists a long-felt need in the art for a touchscreen finger-worn stylus device that enhances user comfort by reducing strain on the fingertip during extended use.

The subject matter disclosed and claimed herein, in one embodiment thereof, comprises a touchscreen finger-worn stylus device. The device is designed to enhance the accuracy and usability of touchscreen interactions, particularly in warehouse, retail, and logistics environments. The device comprises a flexible sleeve-like body that fits securely over a user's finger. The device features a stylus tip made from conductive materials to ensure precise capacitive touchscreen input. The stylus tip may be interchangeable, with options such as a precision rubber tip, soft conductive foam tip, or fine-point stylus tip, secured via an attachment mechanism. Some embodiments of the device include a pressure-sensitive layer for variable touch input and a pressure-relief insert to reduce fingertip strain. The device may also incorporate an adjustable securing mechanism, such as a hook-and-loop strap or elastic band, to prevent unintended movement.

In this manner, the touchscreen finger-worn stylus device of the present invention accomplishes all the foregoing objectives and provides a device that fits securely over the user's finger such that the finger can be used as a touchscreen stylus. More specifically, the stylus tip ensures accurate and responsive interaction with capacitive touchscreens, reducing input errors and increasing efficiency. Additionally, the stylus tip may be interchangeable, allowing users to select different tip types based on their specific application needs. A pressure-relief insert positioned between the stylus tip and fingertip minimizes discomfort, making the device suitable for prolonged use. By integrating these features, the touchscreen finger-worn stylus device enhances accuracy, facilitates multitasking, and improves overall user comfort, making it a valuable tool for professionals in retail, logistics, and inventory management.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a touchscreen finger-worn stylus device. The device enhances accuracy and ease of interaction with touchscreen devices, particularly in warehouse, retail, and logistics environments. It improves precise selection of small on-screen buttons on scanning guns, tablets, and other handheld touchscreen-operated devices. The device comprises a flexible body in the form of a sleeve that securely fits over a user's finger. In one embodiment, an adjustable securing mechanism, such as a hook-and-loop strap, elastic band, or adhesive strip, enhances fit stability and prevents unintended movement during use.

The body is further comprised of a stylus tip that serves as the primary interface with touchscreen devices. The stylus tip may be made from conductive materials to ensure precise input with minimal latency. In one embodiment, the stylus tip is interchangeable and can be replaced based on specific tasks. Variants of the tip may include precision rubber tips for detailed selections, soft conductive foam tips for smooth scrolling, and fine-point stylus tips for high-accuracy applications. The stylus tip is further secured to the body via an attachment mechanism.

In another embodiment, the stylus tip incorporates a pressure-sensitive layer that enables variable touch input, allowing touchscreen devices to recognize different levels of applied pressure for enhanced control. This layer may be composed of resistive or capacitive pressure-sensitive materials. To enhance comfort during extended use, a pressure-relief insert, made of gel, memory foam, or similar cushioning material, may be positioned between the end of the body and the stylus tip to reduce strain on the fingertip.

The invention also includes a method of use, involving inserting a finger into the flexible body, positioning the stylus tip against a touchscreen surface for interaction, and adjusting the fit if necessary. If the stylus tip is interchangeable, users may replace it using the attachment mechanism to suit specific applications.

Accordingly, the touchscreen finger-worn stylus device of the present invention is particularly advantageous as it provides a device that fits securely over the user's finger such that the finger can be used as a touchscreen stylus. More specifically, the stylus tip ensures accurate and responsive interaction with capacitive touchscreens, reducing input errors and increasing efficiency. Additionally, the stylus tip may be interchangeable, allowing users to select different tip types based on their specific application needs. A pressure-relief insert positioned between the stylus tip and fingertip minimizes discomfort, making the device suitable for prolonged use. By integrating these features, the touchscreen finger-worn stylus device enhances accuracy, facilitates multitasking, and improves overall user comfort, making it a valuable tool for professionals in retail, logistics, and inventory management.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a touchscreen finger-worn stylus device of the present invention in accordance with the disclosed architecture; and

FIG. 2 illustrates a flowchart of a method of using one potential embodiment of a touchscreen finger-worn stylus device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a touchscreen finger-worn stylus device that allows users to accurately select touchscreen elements on scanning guns and other handheld devices. There also exists a long-felt need in the art for a touchscreen finger-worn stylus device that improves workflow efficiency by enabling users to interact with touchscreens while simultaneously handling inventory or equipment. Moreover, there exists a long-felt need in the art for a touchscreen finger-worn stylus device that enhances user comfort by reducing strain on the fingertip during extended use.

The present invention, in one exemplary embodiment, is comprised of a touchscreen finger-worn stylus device. The device improves accuracy and ease of interaction with touchscreen devices, particularly in warehouse, retail, and logistics environments by enhancing the precise selection of small on-screen buttons on scanning guns, tablets, and other handheld touchscreen-operated devices. The device includes a flexible body in the form of a sleeve that securely fits over a user's finger. In one embodiment, an adjustable securing mechanism, such as a hook-and-loop strap, elastic band, or adhesive strip, enhances fit stability and prevents unintended movement during use. The device will be most beneficial to postal and delivery services, such as UPS, Amazon, etc. The device is worn snuggly on the finger and will not interfere with operating a vehicle, forklift, clamp truck, etc.

The body further incorporates a stylus tip that serves as the primary interface with touchscreen devices. The stylus tip may be made from conductive materials to ensure precise input with minimal latency. In one embodiment, the stylus tip is interchangeable and can be replaced based on specific tasks. Variants may include precision rubber tips for detailed selections, soft conductive foam tips for smooth scrolling, and fine-point stylus tips for high-accuracy applications. The stylus tip is secured to the body via an attachment mechanism.

In another embodiment, the stylus tip includes a pressure-sensitive layer that enables variable touch input, allowing touchscreen devices to recognize different levels of applied pressure for enhanced control. This layer may be made of resistive or capacitive pressure-sensitive materials. To improve comfort during extended use, a pressure-relief insert, made of gel, memory foam, or similar cushioning material, may be positioned between the end of the body and the stylus tip to reduce strain on the fingertip.

The invention also comprises a method of use, involving inserting a finger into the flexible body, positioning the stylus tip against a touchscreen surface for interaction, and adjusting the fit if necessary. If the stylus tip is interchangeable, users may replace it using the attachment mechanism to accommodate specific applications.

As a result, the touchscreen finger-worn stylus device is particularly advantageous as it securely fits over the user's finger, allowing it to function as a touchscreen stylus. The stylus tip ensures accurate and responsive interaction with capacitive touchscreens, reducing input errors and improving efficiency. Additionally, the interchangeable stylus tip allows users to select different tip types based on their application needs. A pressure-relief insert positioned between the stylus tip and fingertip minimizes discomfort, making the device suitable for prolonged use. By integrating these features, the touchscreen finger-worn stylus device enhances accuracy, facilitates multitasking, and improves user comfort, making it a valuable tool for professionals in retail, logistics, and inventory management.

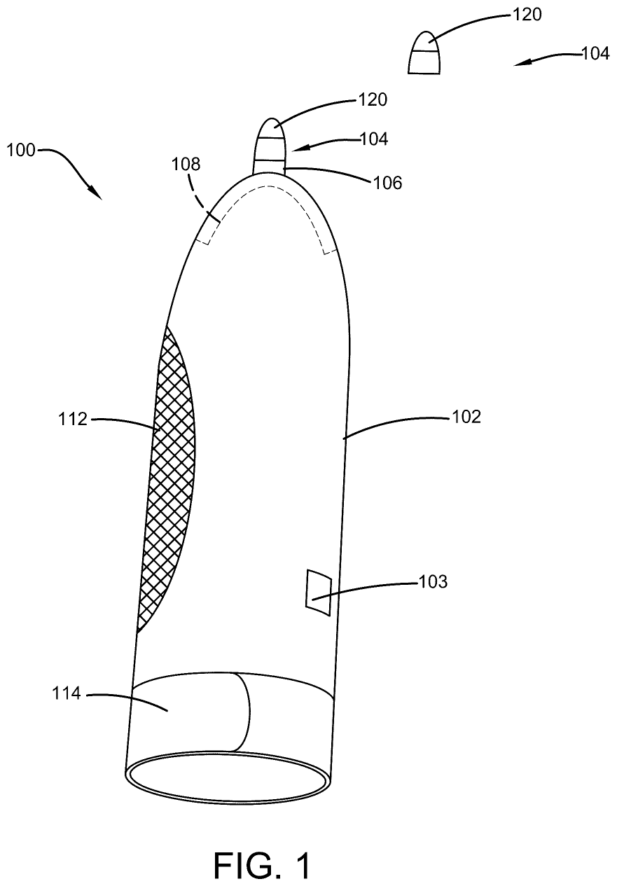

Referring initially to the drawings, FIG. 1 illustrates a perspective view of one potential embodiment of a touchscreen finger-worn stylus device 100 of the present invention in accordance with the disclosed architecture. The touchscreen finger-worn stylus device 100 is designed to improve the accuracy and ease of interacting with touchscreen devices, particularly in warehouse, retail, and logistics environments. More specifically, the device 100 improves the usability of selecting small on-screen buttons accurately on scanning guns, tablets, or other handheld touchscreen-operated devices.

The device 100 is comprised of a flexible body 102 in the form of a sleeve that fits securely over a user's finger. The body 102 is preferably made from a stretchable material such as silicone, thermoplastic elastomer, or an elastic fabric blend, ensuring a snug fit across different finger sizes. In one embodiment, the body 102 may feature a breathable design with perforations or mesh areas 112 to enhance airflow, as seen in FIG. 1. Additionally, in one embodiment, the body 102 may be made from a moisture-wicking material to minimize sweat buildup and improve overall comfort. Given the nature of warehouse and retail environments, where exposure to dust, grease, and sanitizing solutions is common, the body 102 may include a protective coating 103 that enhances resistance to environmental contaminants. The protective coating 103 may be a hydrophobic or oleophobic coating in one embodiment to repel water, cleaning agents, and other substances, ensuring the device 100 remains durable while maintaining touchscreen responsiveness.

While the device 100 is primarily designed for use on the index finger, alternative configurations may allow the device 100 to be worn on the thumb, middle finger, or other digits. This multi-finger compatibility provides users with the flexibility to choose a configuration that best aligns with their specific workflow, particularly when handling scan guns, tablets, or other handheld touchscreen devices.

In one embodiment, the device 100 may further include an adjustable securing mechanism 114 to enhance fit stability, as seen in FIG. 1. The adjustable securing mechanism 114 may be a hook-and-loop strap, an elastic band, or an adhesive strip, preventing unintended movement of the device 100 during use.

The body 102 is comprised of a stylus tip 104 that serves as the primary interface with touchscreen devices when the device 100 is used, as seen in FIG. 1. The stylus tip 104 may be constructed from material such as, but not limited to, conductive rubber, conductive foam, or other materials optimized for capacitive touchscreen compatibility. For enhanced touchscreen responsiveness, the stylus tip 104 may be made from high-quality conductive materials such as copper-infused rubber, silver-coated fibers, or other advanced composites. These materials ensure precise input with minimal latency, making the device 100 more effective for rapid and frequent touchscreen interactions.

In one embodiment, the stylus tip 104 may be interchangeable and removable from the body 102, allowing users to replace or swap different tip types based on specific tasks. Tip 104 variations may include a precision rubber tip for detailed selections, a soft conductive foam tip for smooth scrolling, and a fine-point stylus tip for high-accuracy applications. The stylus tip 104 may be attached to the body 102 via an attachment mechanism 106. The attachment mechanism 106 may be a snap-fit connection, a threaded coupling, or another suitable fastener to secure the selected stylus tip 104 in place.

In another embodiment, the stylus tip 104 may include a pressure-sensitive layer 120 that enables variable touch input, allowing touchscreen devices to recognize different levels of pressure for more precise control, as seen in FIG. 1. The pressure-sensitive layer 120 may be comprised of resistive or capacitive pressure-sensitive materials that modulate input based on applied force.

To improve comfort during extended use, a pressure-relief insert 108 may be positioned between the end of the body 102 and the stylus tip 104. The pressure-relief insert 108 may be made of gel, memory foam, or another cushioning material to reduce strain on a user's fingertip.

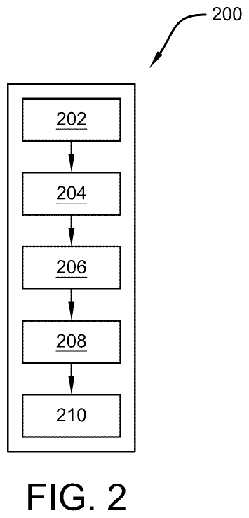

The present invention is also comprised of a method of using 200 the device 100, as seen in FIG. 2. First, a device 100 is provided, comprising a flexible body 102 in the form of a sleeve, a stylus tip 104, and an attachment mechanism 106 [Step 202]. Then, the user inserts their finger into the body 102 [Step 204]. Next, the user positions the stylus tip 104 against the touchscreen surface of a device, such as a scanning gun, tablet, or other handheld touchscreen-operated device, to interact with on-screen elements accurately [Step 206]. If necessary, the user can adjust the fit of the device 100 using an adjustable securing mechanism 114, if present [Step 208]. Optionally, if the stylus tip 104 is interchangeable, the user can replace the tip 104 by detaching it via the attachment mechanism 106 and securing a different stylus tip 104 optimized for a specific application [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “touchscreen finger-worn stylus device” and “device” are interchangeable and refer to the touchscreen finger-worn stylus device 100 of the present invention.

Notwithstanding the foregoing, the touchscreen finger-worn stylus device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the touchscreen finger-worn stylus device 100 as shown in the FIGS. are for illustrative purposes only, and that many other sizes and shapes of the touchscreen finger-worn stylus device 100 are well within the scope of the present disclosure. Although the dimensions of the touchscreen finger-worn stylus device 100 are important design parameters for user convenience, the touchscreen finger-worn stylus device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A touchscreen finger-worn stylus device comprising:
a body configured to be worn on a finger; and
a stylus tip positioned on the flexible body.

2. The touchscreen finger-worn stylus device of claim 1, wherein the stylus tip is comprised of a conductive material.

3. The touchscreen finger-worn stylus device of claim 1, wherein the body is comprised of a hydrophobic coating.

4. The touchscreen finger-worn stylus device of claim 1, wherein the body is comprised of a oleophobic coating.

5. The touchscreen finger-worn stylus device of claim 1, wherein the body is comprised of a perforation.

6. The touchscreen finger-worn stylus device of claim 1 further comprising an adjustable secure mechanism.

7. The touchscreen finger-worn stylus device of claim 1, wherein the body is comprised of a moisture-wicking material.

8. A touchscreen finger-worn stylus device comprising:
a flexible body configured to be worn on a finger; and
a stylus tip removably attached to the flexible body via an attachment fastener, wherein the stylus tip is comprised of a pressure-sensitive layer configured to enable variable touch input based on applied force.

9. The touchscreen finger-worn stylus device of claim 8, wherein the flexible body is comprised of a mesh area.

10. The touchscreen finger-worn stylus device of claim 8, wherein the pressure-sensitive layer is comprised of a resistive pressure-sensitive material.

11. The touchscreen finger-worn stylus device of claim 8, wherein the pressure-sensitive layer is comprised of a capacitive pressure-sensitive material.

12. The touchscreen finger-worn stylus device of claim 8, wherein the attachment fastener is comprised of a snap-fit fastener.

13. The touchscreen finger-worn stylus device of claim 8, wherein the attachment fastener is comprised of a threaded fastener.

14. The touchscreen finger-worn stylus device of claim 8 further comprised of a pressure-relief insert.

15. The touchscreen finger-worn stylus device of claim 14, wherein the pressure-relief insert is positioned below the stylus tip.

16. The touchscreen finger-worn stylus device of claim 15, wherein the pressure-relief insert is comprised of a memory foam.

17. The touchscreen finger-worn stylus device of claim 15, wherein the pressure-relief insert is comprised of a gel.

18. A method of using a touchscreen finger-worn stylus device, the method comprising the following steps:
providing a touchscreen finger-worn stylus device comprised of a flexible body configured to be worn on a finger, the flexible body comprised of a stylus tip;
inserting a user's finger into the flexible body; and
positioning the stylus tip against a touchscreen surface to interact with the touchscreen surface.

19. The method of using a touchscreen finger-worn stylus device of claim 18 further comprising a step of removing the stylus tip from the flexible body.

20. The method of using a touchscreen finger-worn stylus device of claim 19 further comprising a step of attaching a second stylus tip of a different style to the flexible body.
